(19) United States
(12) Patent Application Publication
(10) Pub. No.: US 2003/0120559 A1
(43) Pub. Date: Jun. 26, 2003

(54) System and method of distributing public relations and marketing content

(76) Inventor: Joel C. Don, Trabuco Canyon, CA (US)

Correspondence Address: CROCKETT & CROCKETT, 24012 CALLE DE LA PLATA, SUITE 400, LAGUNA HILLS, CA, 92653, US

(21) Appl. No.: 10/322,410

(22) Filed: Dec. 17, 2002

Related U.S. Application Data
(60) Provisional application No. 60/344,599, filed on Dec. 21, 2001.

(51) Int. Cl. G06F 17/60

(52) U.S. Cl. 705/26

(57) ABSTRACT

A system and method of distributing public relations and marketing content via the Internet. Information producers register with a central database their pertinent company information, which is indexed and stored in a central database. The information producers receive a unique identifier that is also indexed with their company information in the central database. This unique identifier is encoded into all press releases or other news content submitted by the information producer to the central database and through commercial wire services. Information consumers may craft highly complex searches and submit them to the central server for processing. A statistical processor and server report back to the information producers data regarding the number of times they are selected for news content tracking and also the number of times each news content is accessed.

### RELATED PATENT APPLICATION

This patent application claims priority to U.S. provisional patent application No. 60/344,599, filed Dec. 21, 2001.

### FIELD OF THE INVENTIONS

The inventions described below relate generally to news content distribution, and in particular, to a system and method of distributing public relations and marketing information via the Internet.

### BACKGROUND OF THE INVENTIONS

Many organizations use a variety of tactical marketing programs to communicate messages in an effort to create interest and awareness of their products, services and initiatives. These programs include distributing advertising, direct mail, promotional materials and press releases (collectively referred to in this application as “news content”). Every year, U.S. private and public companies spend billions of dollars for public relations services designed to deliver news content to the press and public.

One of the more common ways to communicate company messages is in the form of a press release. Today, the majority of news generated by newspapers, magazines, broadcasters and Internet news portals is based on such official corporate announcements.

The advent of the Internet has offered companies a medium for distributing news content such as press releases. FIG. 1 illustrates the conventional method of distributing news content on the Internet today. To achieve the widest distribution and to leverage the reach of the Internet, many information producers submit press releases to one of several fee-based commercial press release wire services, such as Business Wire and PR Newswire. The commercial press release wire services authenticate the sending source, edit the releases for common news style and review content for libel and other potential legal issues. These services offer a single-source means of information distribution to a wide array of print and broadcast news media (CNN, USA Today, etc.), research/archival database services (LexisNexis, Dialog, etc.), Internet content syndicators and information aggregators (COMTEX News Network, NewsEdge, etc.) and various Internet portals and Web sites.

Business Wire and PR Newswire report that nearly 80,000 member companies in the U.S. use their services to issue an average of 2,000 to 3,000 press releases per day. Worldwide, the total number of companies and other groups regularly issuing press releases numbers in the hundreds of thousands. In this knowledge economy, it is estimated that employees spend upwards of 10 hours per week finding, gathering and analyzing external information content, or 16-percent of the workweek. In the U.S., this activity translates into an estimated salary cost of $107 billion per year.

Today, more than 95 percent of all press releases from companies and organizations are screened and filtered by news media or gatekeepers. Gatekeepers are the print media reporters and editors and broadcast producers who traditionally screen and filter the vast majority of information producers' news content. Gatekeepers are an impediment to the full distribution of content, publishing or broadcasting a very small percentage of this information. In addition, fees charged by research/archival database services and content syndicators and information aggregators are often cost-prohibitive for most information consumers. News content delivered to Internet portals and Web sites can be searched, but only through rudimentary and often fruitless keyword search methodologies. Or information consumers are deluged with an excess of news content because information is filtered only by broad industry categories. Thus, the chances that a given press release will reach its intended audience through the current system are slim.

Despite these gross inefficiencies, corporations and organizations remain committed to this kind of information acquisition because highly reliable, up-to-date business information is a valued asset that is used to make complex and sophisticated business decisions. Navigating this morass of information is not just time consuming but nearly impossible. As a result, market and competitive intelligence professionals, business analysts and information professionals spend thousands of dollars to subscribe to fee-based information database providers, news content syndicators or information aggregators to track and retrieve this information. However, even these fee-based services do not offer a sophisticated search methodology or technology that would enable users to pinpoint specific information or design highly refined and complex search requests.

The Internet lacks a comprehensive and systematic method for delivering news content from companies and organizations to business professionals, corporate consumers and the general public. Therefore, a need exists for a cost-effective and efficient system and method for the delivery of company and organization news content and press releases directly to business professionals and other news seekers. Further, a need exists to enable press releases to be used as a more effective delivery vehicle for various forms of marketing communications and advertising.

### SUMMARY

The Universal Internet Registry is a membership-based database marketing service serving public and private businesses, organizations, non-profit agencies, government institutions and any group that issues press releases to communicate company news, product marketing announcements, news media alerts, sales notices and other forms of timely, dynamic information. Information producers become members by registering pertinent company information with a central database server. Each information producer is then assigned a unique identifier, or ticker symbol-like label or tag. This unique identifier is encoded into all news content submitted by the information producer and is linked to a sophisticated information producer registration database. The unique identifier enables information and news from companies and organizations to be easily tracked, indexed, retrieved and archived.

The invention demonstrates several advantages and benefits over conventional news and press release distribution systems. It provides a direct link to targeted audiences, alleviates news delivery bottlenecks and eliminates media screening and filtering. It delivers important news and other marketing information to business professionals without delay and at little or no cost to them. It offers these decision-makers a competitive advantage by helping them sift through vast amounts of data and weed through volumes of irrelevant information.

The Universal Internet Registry solution is differentiated from content aggregators, news syndicators and database services. It targets the delivery of press releases—the source of most published news—through free or low-cost real-time search and tracking services to be provided by third-party affiliate search engines, portals and other “open Internet” destinations.

The Universal Internet Registry offers businesses measurement and accountability through the consolidation and statistical analysis of highly valued end-user selection data. For example, companies will know how many people are actively watching for their news as well as the total number of readers for each individual news announcement.

The unique identifier code or tag generated for each information producer is simply edited into press releases, which are then issued via one of the bona fide commercial press release distribution services. Commercial release services, such as Business Wire and PR Newswire, represent an essential element in the process. To guarantee that all company issuances and codes are valid, these wire services will have the responsibility to authenticate the originating source for each release prior to acceptance by the Universal Internet Registry database system and subsequent distribution to affiliate Web sites. In that respect, the commercial wire services accept liability for the authenticity of all content managed by the Universal Internet Registry process.

Information consumers or users include business professionals, government workers, educators, students, non-profit groups, the general public and others who will benefit from a system that offers unfiltered access to the sum total of company-issued news and marketing information distributed via the Internet. The system benefits venture capitalists and industry analysts who require a comprehensive tool for researching startups and new enterprises as well as established businesses. Corporate information analysts, marketing professionals and knowledge workers will be able to stay on top of any number of industries and companies as well as easily survey the market for new, competitive threats. Most important, as the system develops with affiliate license relationships, users will be able to set up news tracking pages at any number of preferred Web destinations, at virtually no cost for basic services.

### BRIEF DESCRIPTION OF THE DRAWINGS

FIG. 1 illustrates a block diagram of a news content distribution system, according to the prior art.

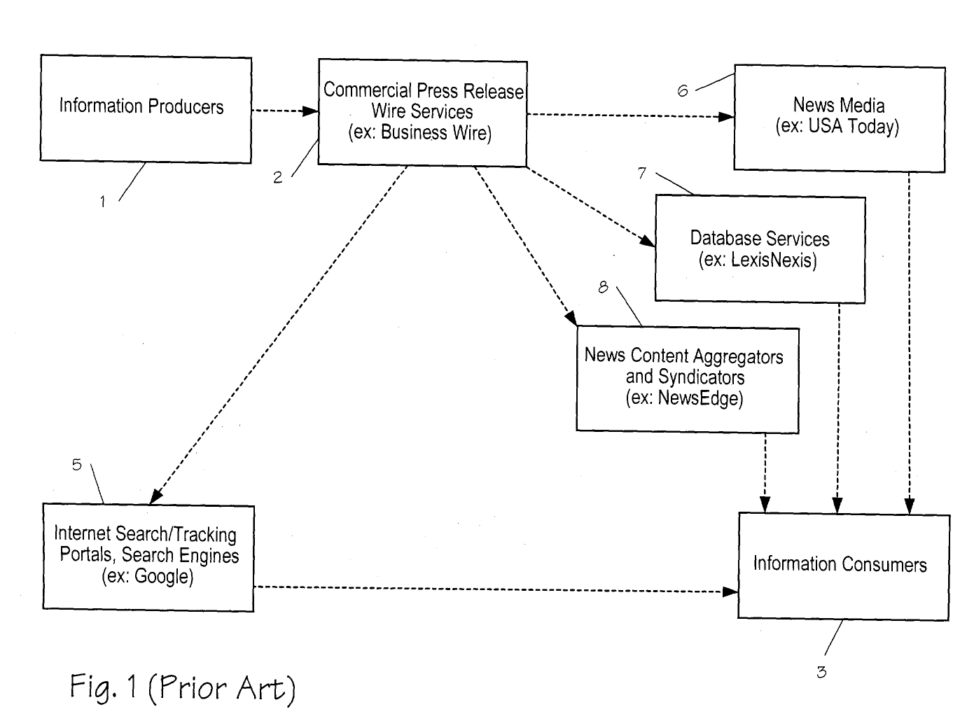

FIG. 2 illustrates a block diagram of a news content distribution system.

FIG. 3 illustrates a diagram of a network architecture of the system connecting information producers and information consumers with a statistical data management system useful with the system illustrated in FIG. 2.

### DETAILED DESCRIPTION OF THE INVENTIONS

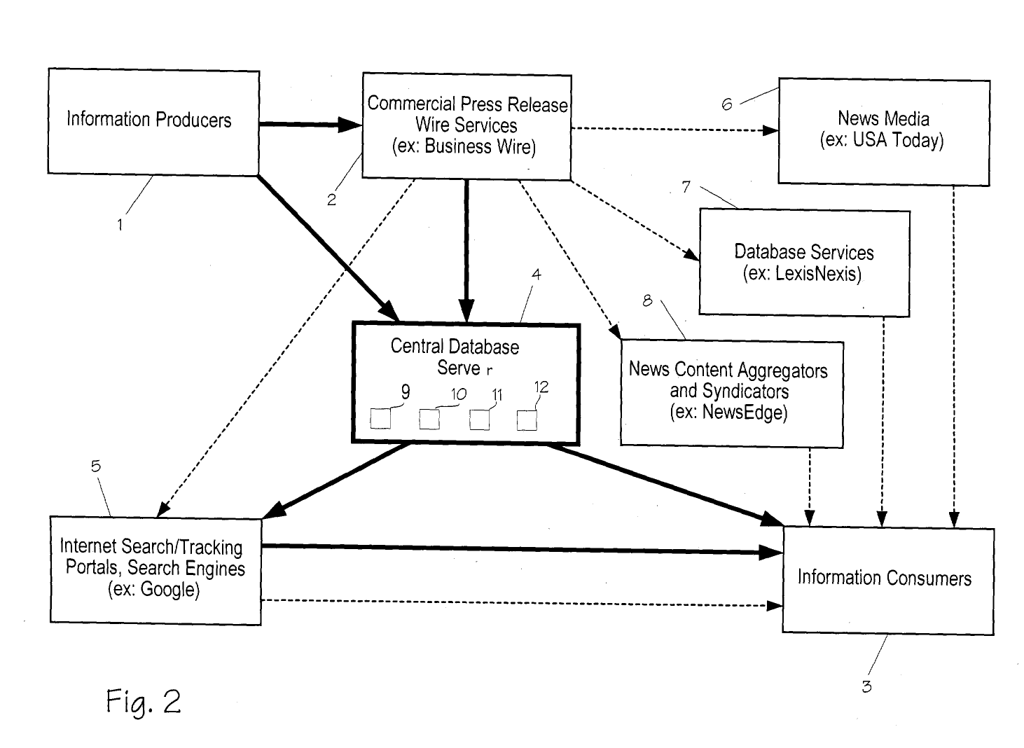

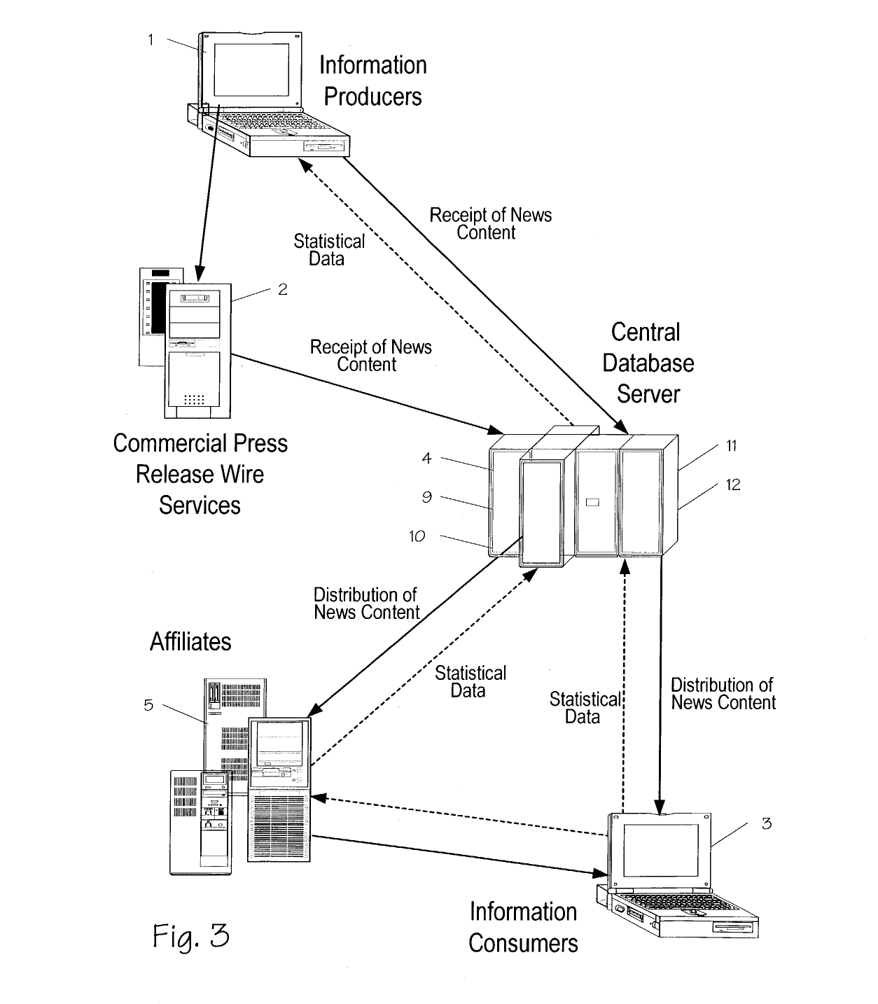

FIGS. 2 and 3 illustrate the Universal Internet Registry system, comprising information producers 1 and commercial press release wire services 2, information consumers 3, and the central database server 4. Though not required, other participants of the system may include affiliates 5, news media 6, database services 7, and news content aggregators and syndicators 8.

Information producers 1 and commercial press release wire services 2 are clients who communicate with the central database server 4 via the Internet. Information producers are those companies, organizations and persons who want their news content provided to the public, doing so in various forms including but not limited to press releases. They include public and private companies, non-profit organizations, educational institutions, government agencies and individuals. Commercial press release wire services receive announcements from information producers, authenticate the sending source, edit the releases for common news style, and review content for libel and other potential legal issues. Commercial press release wire services such as Business Wire and PR Newswire widely distribute the majority of news and marketing announcements worldwide to print and broadcast media and Internet portals and other Web sites.

Information consumers 3 are clients who communicate directly and indirectly with the central database server 4 via the Internet. Information consumers are those persons who want to receive news content. They include companies, non-profit groups, competitors, investors, industry analysts, venture capitalists, financial analysts as well as marketing, sales, finance, engineering and administration professionals. These groups heavily rely on relevant, high-quality information for daily decision-making. Information consumers may also include educators, government employees, non-profit groups, the general public and others.

Affiliates 5, news media 6 (CNN, USA Today, etc.), database services 7 (LexisNexis, etc.), and news content aggregators and syndicators 8 are potential clients who communicate directly with the central database server via the Internet. Affiliates, including major open Internet search engines and portals such as Google, Yahoo, Lycos and Ask Jeeves, serve as primary destination sites for many Internet users. There are also many thousands of other major and minor Web sites and portals favored by various users.

The central database server 4 provides various functions, including a company/organization registration database and server 9, an information consumer/user registration database and server 10, a news content database and server 11, and a statistical processing database and server 12. It should be appreciated by one skilled in the art that these functions can be implemented via one central database and server, four separate databases and servers within the one central database and server, or spread throughout the Internet.

Resident in the central database server is a company/organization registration database and server 9. Information producers desiring to join the Universal Internet Registry are required to register pertinent company information with the company/organization registration database and server. Such information may include company name, location, contact information, financial information, industry sector, Web address, and the like. The registration database will also contain, where appropriate, SIC (Standard Industrial Classification) and NAICS (North American Industry Classification System) codes, designated market area (DMA) information, ticker symbol, industry market segment, keywords, geographic location, company size, products and services, and many other details. Registration information may be submitted via an online form, e-mail, telephone, fax or by postal mail. Registration information is sent to and stored in the company/organization registration database and server.

Once an information producer has registered with the Universal Internet Registry as a member of the system, a unique identifier is assigned to that information producer. All matter associated with a particular information producer is tagged with this unique identifier. The unique identifier, in its simplest form, is an alphanumeric character similar to a ticker symbol, airline code, airport code, ZIP code, or the like. The unique identifier can simply be a randomly generated number. The unique identifier could also have some symbolic meaning, such as a company name or stock ticker. The unique identifier could be an intelligent tag. For example, there could be some coding system established to group members by their industry, such as service, product, DMA, SIC, etc. Changes to a member's product line or industry sector could be taken into account by assigning a new unique identifier, modifying the current unique identifier, or other suitable tracking mechanism. Essentially, the unique identifier could be simple or flexible and intelligent.

In its more complicated form, the unique identifier is akin to UPC codes, comprising two distinct parts. The first part is the unique company identifier previously discussed. The second part could track the member's products (in this case, news content). For example, when Company A becomes a member, Company A is assigned a unique identifier AAA. When Company A submits its first press release, press release Number 1 is assigned product identifier 0001. The unique identifier associated with the first press release of Company A is therefore AAA-0001. Press release numbering can be managed by the member or alternatively by a manager within the Universal Internet Registry system.

An information consumer may register in a similar way and be assigned a unique identifier. Alternatively, an information consumer may simply register and obtain an account number and associated password. Registration information is sent to and stored in the information consumer/user registration database and server 10.

The central database server further comprises a news content database and server 11. The news content database warehouses all press releases submitted by information producers registered with the company/organization registration database and server. Press releases may be stored for a flexible period of time. An information producer sends its news content to the news content database and server by way of the commercial press release wire services. For every piece of news content submitted by the information producer to the news content database and server, that news content is tagged with the unique company identifier. The unique identifier is edited into a press release before its transmittal to the commercial press release wire service or by the commercial press release wire service. Press releases are organized in any number of ways, be it by unique identifier, industry, company name, alphabetically, or other.

Information producers may bypass the commercial press release wire services and send news content directly to the news content database and server 11. In this manner, the news content provided loses the benefit of the commercial wire services' ability to widely disseminate such information to print and broadcast news media, but a market may exist for such content for which the Universal Internet Registry system could provide a separate distribution channel specifically geared for information not in the form of a typical press release (advertisements, brochures, speeches, political messages, fund-raising notices, etc.) or for information producers who elect not to use commercial press release wire services because reaching news media is not their most immediate objective.

The central database server 4 further enables any information consumer with Internet access to retrieve news content in a number of ways. The registration database can be searched by a variety of basic and extended criteria, including company name, location, size and revenue. By utilizing various descriptor field options, such as SIC and NAICS classifications, DMA assignment, product/services data and other descriptors, information consumers will be able to conduct extremely targeted searches for businesses and organizations or other types of very specific information. The information consumer may search for information directly on the Universal Internet Registry Web site. Alternatively, an information consumer can fashion a standing search request and receive search results periodically via e-mail, paging, instant messaging, etc. For example, if an information consumer wishes to receive information relevant to Company A, that search may be stored and whenever information regarding Company A is available, the user is notified via e-mail, pager, instant messaging, etc.

Affiliates 5 may provide a valuable role in the Universal Internet Registry system. Internet search engines, Web portals, online news and financial sites and general interest sites will be able to link to the Universal Internet Registry system and obtain access to the central database server, including the company/organization registration database and server, news content database and server, and statistical database and server. Through real-time links and electronic hooks into the central database server, affiliate service providers will be able to offer users a variety of value-added services, including customized Web pages, direct e-mail distribution and e-mail alerts, and instant-messaging services.

The central database server may also comprise a statistical processing database and server 12 for collecting and storing statistical information about user interests and the effectiveness of certain news content, as shown in FIG. 3. For example, the central database server collects statistical information on how many users are tracking individual companies and the statistical quantity of users opening or viewing specific news content. This information is made available to the information producer that submitted the news content as well as to other companies, organizations and individuals interested in such statistical business data. For example, all news content for Company A is encoded with the unique identifier AAA. Whenever that company is selected by an information consumer for news content tracking, a counter is tolled. The statistical processing database and server looks for unique identifier AAA and counts the number of hits. Also, where the unique identifier is more complex and contains a product number, the statistical processing database and server can count the number of hits, for example, for AAA-0001. As may be appreciated by one skilled in the art, this is just one of many different ways of tracking statistical data.

There are several advantages to this feature. One advantage is that information producers that send out press releases can determine how many people are interested in their activities, products, services and initiatives. Further, these companies can ascertain the number of people reading specific press releases. Using this information, companies can determine what type of news content is more effective for the dissemination of company information, the sale of products and services, the communication of company initiatives and other marketing communications objectives. Thus, this feature enables companies to continually improve the effectiveness of their various marketing communications programs. Another advantage is that companies can determine what products and services the news seekers are more interested in by viewing the effectiveness of specific press releases that contain information about those products or services.

In use, an information producer registers its company information with the Universal Internet Registry central database server. Upon registering, the information producer is assigned its unique identifier. All press releases associated with this information producer are tagged with this unique identifier. The information producer is now ready to make its news content available on the central database server. The information producer creates its news content, tags it with the unique identifier, and sends it to the commercial press release wire services to be edited, legally checked and prepared for dissemination. The commercial press release wire service sends the news content to the central database server, preferably in electronic form, via the Internet. The press release is stored on the news content database within the central database server in an organized fashion, under the information producer's unique identifier, and according to industry, location, or other manner.

An information consumer wishes to receive information about the information producer. The information consumer may go to the Universal Internet Registry Web site and craft a search to find the relevant information. At the Universal Internet Registry Web site, the information consumer might look under a pertinent category on the Universal Internet Registry Web page, such as “Today's News.” The consumer might create a specific search on the Universal Internet Registry Web page, such as “computer software developers, California, Irvine, revenue is greater than $5 million and less than $100 million, employee headcount is greater than 30.”

The information consumer may also cast a search with a familiar affiliate. The affiliate member incorporates the searching capability of the Universal Internet Registry into its existing system, netting a better result than with the conventional methods employed today. The search results in a list of unique identifiers that match the information consumer's search criteria. The information consumer may store that search in his account and name it, for example “Tracking list No. 1 for computer software developers.” The saved search will continually scan the central database server for the unique identifiers such that each time information providers associated with the unique identifiers submit press releases, the press releases will be pulled and sent to the information consumer.

Revenue may be generated from this system in a number of ways. Information producers desiring to become a member would pay a fee upon registration and receipt of the unique identifier. Information producers could be charged a fee per press release submission. Information consumers and affiliates could pay a fee to join. Information consumers could pay a fee per search. Information producers and information consumers also could pay for statistical data produced by the system.

Thus, while the preferred embodiments of the systems and methods have been described in reference to the environment in which they were developed, they are merely illustrative of the principles of the inventions. Other embodiments and configurations may be devised without departing from the spirit of the inventions and the scope of the appended claims.

I claim:

1. A system for distributing news content, said news content being provided from a plurality of information producer clients, through commercial press release wire services, to a plurality of information consumer clients, said information producer clients having company information, said system comprising:
a central database server, said central database server being programmed to receive requests from an information producer client to register company information with the central database server, store said company information, assign a unique identifier to said information producer client, and report to the information producer client the unique identifier, wherein said information producer client embeds the news content with the unique identifier;
said central database server further being programmed to receive from the information producer client news content with the embedded unique identifier, store said news content, and index said news content by unique identifier; and
said central database server further being programmed to receive a search request from an information consumer client, wherein said search request includes desirable company information values, process the search request, report a search result listing one or a plurality of unique identifiers that correspond to companies having matching company information values, and return news content indexed by the unique identifiers that correspond to companies having matching company information values

2. The system of claim 1 wherein said central database server is further programmed to collect statistical information, store said statistical information, and report said statistical information.

3. A system for distributing press releases, said press releases being provided by a plurality of information producer clients, through commercial press release wire services, to a plurality of information consumer clients, said information producer clients having company information, said system comprising:
a company/organization registration database server, said company/organization registration database server being programmed to receive requests from an information producer client to register company information with the company/organization registration database server, store said company information, assign a unique identifier to said information producer client, return said unique identifier to the information producer client, wherein said information producer client encodes the unique identifier into its press release;
said company/organization registration database server further being programmed to receive a first search request from an information consumer client, wherein said search request includes desirable company information values, process the first search request, and report a first search result listing one or a plurality of unique identifiers that correspond to companies having matching company information values;
a news content database and server, said news content database and server being programmed to receive press releases with the embedded unique identifier from an information producer client and store said press releases; and
said news content database and server further being programmed to process a second search request from the company/organization registration database server for press releases matching the unique identifiers identified in the first search result, and return press releases matching the unique identifiers.

4. A system for distributing news content, said news content being provided from a plurality of information producer clients to a plurality of information consumer clients, said information producer clients having company information, said system comprising:
a company/organization registration database server, said company/organization registration database server being programmed to receive requests from an information producer client to register company information with the company/organization registration database server, store said company information, assign a unique identifier to said information producer client, and return to the information producer client the unique identifier, wherein said information producer client embeds its news content with the unique identifier;
a news content database and server, said news content database and server being programmed to receive from an information producer client news content with the embedded unique identifier, store said news content, index said news content, receive a first search request from an information consumer client, wherein said search request includes desirable company information values, and redirect the search request to the company/organization registration database server to determine the unique identifier for the desirable company information values,
said company/organization registration database server further being programmed to receive the redirected first search request from the news content database and server, process the search request, return a first search result with unique identifiers that correspond to companies having matching company information values; and
said news content database and server further being programmed to search the news content database and server for news content matching the unique identifiers associated with the first search result, and return the news content matching the unique identifiers identified in the first search result.

5. A method for distributing news content in a distributed system, comprising:
receiving a request to register company information from a company,
assigning a unique identifier to the company,
encoding all news content from the company with the unique identifier,
storing news content in a server accessible to information producer clients,
receiving a first search request from an information consumer client,
providing a list of unique identifiers associated with the first search request,
receiving a search request for news content encoded with the unique identifier associated with the first search request, and
providing news content matching the unique identifier associated with the first search request to the information consumer clients.

6. The method of claim 5 further comprising charging a fee to assign a unique identifier to a company.

7. The method of claim 5 further comprising charging information consumer clients based on news content transmitted.

8. The method of claim 5 further comprising providing news content to information consumer clients without filtering.

9. The method of claim 5 further comprising periodically updating the list of unique identifiers associated with the first search request and periodically transmitting newly acquired news content matching the unique identifiers associated with the first search request.

10. The method of claim 5 further comprising providing substantially all news content received to information consumer clients in response to searches.

11. The method of claim 5 further comprising collecting statistical information, storing said statistical information, and reporting said statistical information.

12. An apparatus for distributing news content in a distributed system, comprising:
means for receiving a request to register an information producer client's company information;
means for assigning a unique identifier to the information producer client;
means for associating the unique identifier with the information producer client's news content;
means for receiving and storing the information producer client's news content;
means for receiving an information consumer client's search request;
means for providing a list of unique identifiers associated with the information consumer client's search request;
means for searching for all news content associated with the list of unique identifiers associated with the information consumer client's search request; and
means for providing a list of news content associated with the information consumer client's search request.

13. The apparatus of claim 12 further comprising a means for collecting statistical information, storing said statistical information, and reporting said statistical information.
